(19) United States
(12) Patent Application Publication
(10) Pub. No.: US 2005/0238575 A1
(43) Pub. Date: Oct. 27, 2005

(54) ITQ-25, new crystalline microporous material

(76) Inventors: Avelino Corma, Valencia (ES); Maria Jose Diaz, Valencia (ES); Fernando Rey, Valencia (ES)

Correspondence Address: EXXONMOBIL RESEARCH AND ENGINEERING COMPANY;(formerly Exxon Research and Engineering Company), P.O. Box 900, Annandale, NJ, 08801-0900, US

(21) Appl. No.: 11/045,727

(22) Filed: Jan. 28, 2005

Related U.S. Application Data
(60) Provisional application No. 60/564,835, filed on Apr. 23, 2004.

(51) Int. Cl. C10G 11/05; C10G 11/00; C01F 7/00

(52) U.S. Cl. 423/700; 208/310 Z; 208/120.01

(57) ABSTRACT

ITQ-25 (INSTITUTO DE TECNOLOGÍA QUÍMICA number 25) is a new crystalline microporous material with a framework of tetrahedral atoms connected by atoms capable of bridging the tetrahedral atoms, the tetrahedral atom framework being defined by the interconnections between the tetrahedrally coordinated atoms in its framework. ITQ-25 can be prepared in silicate compositions with a organic structure directing agent. It has a unique X-ray diffraction pattern, which identifies it as a new material. ITQ-25 is stable to calcination in air, absorbs hydrocarbons, and is catalytically active for hydrocarbon conversion.

This application claims benefit of U.S. Provisional Application No. 60/564,835 filed Apr. 23, 2004.

### BACKGROUND OF THE INVENTION

Microporous materials, including zeolites and silicoaluminophosphates, are widely used in the petroleum industry as absorbents, catalysts and catalyst supports. Their crystalline structures consist of three-dimensional frameworks containing uniform pore openings, channels and internal cages of dimensions (<20 Å) similar to most hydrocarbons. The composition of the frameworks can be such that they are anionic, which requires the presence of non-framework cations to balance the negative charge. These non-framework cations, such as alkali or alkaline earth metal cations, are exchangeable, either entirely or partially with another type of cation utilizing ion exchange techniques in a conventional manner. If these non-framework cations are converted to the proton form by, for example, acid treatments or exchange with ammnium cations followed by calcination to remove the ammonia, it imparts the material with Bronstead acid sites having catalytic activity. The combination of acidity and restricted pore openings gives these materials catalytic properties unavailable with other materials due to their ability to exclude or restrict some of the products, reactants, and/or transition states in many reactions. Non-reactive materials, such as pure silica and aluminophosphate frameworks are also useful and can be used in absorption and separation processes of liquids, gases, and reactive molecules such as alkenes.

The family of crystalline microporous compositions known as molecular sieves, which exhibit the ion-exchange and/or adsorption characteristics of zeolites are the aluminophosphates, identified by the acronym AlPO, and substituted aluminophosphates as disclosed in U.S. Pat. Nos. 4,310,440 and 4,440,871. U.S. Pat. No. 4,440,871 discloses a class of silica aluminophosphates, which are identified by the acronym SAPO and which have different structures as identified by their X-ray diffraction pattern. The structures are identified by a numerical number after AIPO, SAPO, MeAPO (Me=metal), etc. (Flanigen et al., Proc. 7th Int. Zeolite Conf., p. 103 (1986) and may include Al and P substitutions by B, Si, Be, Mg, Ge, Zn, Fe, Co, Ni, etc. The present invention is a new molecular sieve having a unique framework structure.

ExxonMobil and others extensively use various microporous materials, such as faujasite, mordenite, and ZSM-5 in many commercial applications. Such applications include reforming, cracking, hydrocracking, alkylation, oligomerization, dewaxing and isomerization. Any new material has the potential to improve the catalytic performance over those catalysts presently employed.

There are currently over 150 known microporous framework structures as tabulated by the International Zeolite Association. There exists the need for new structures, having different properties than those of known materials, for improving the performance of many hydrocarbon processes. Each structure has unique pore, channel and cage dimensions, which gives its particular properties as described above. ITQ-25 is a new framework material.

### SUMMARY OF THE INVENTION

ITQ-25 (INSTITUTO DE TECNOLOGIA QUIMICA number 25) is a new crystalline microporous material having a framework of tetrahedral atoms connected by bridging atoms, the tetrahedral atom framework being defined by the interconnections between the tetrahedrally coordinated atoms in its framework.ITQ-25 is stable to calcination in air, absorbs hydrocarbons, and is catalytically active for hydrocarbon conversion.

In a preferred embodiment, the new crystalline material is a silicate compound having a composition mR:aX₂O₃:YO₂.nH₂O where R is an organic compound, X is of a trivalent metal capable of tetrahedral coordination such as one or more of B, Ga, Al, and Y is a tetravalent metal capable of tetrahedral coordination such as one or more of Ge, Si, Ti and where m=0.01-1, a=0.00-0.5, and n=0-10 and having a unique diffraction pattern as given in TABLE 2.

In a more preferred embodiment, the calcined crystalline siliate compound has a composition aX₂O₃:YO₂, where X is of a trivalent metal capable of tetrahedral coordination such as one or more of B, Ga, Al, Fe, and Y is a tetravalent metal capable of tetrahedral coordination such as one or more of Ge, Si, Ti and where m=0.01-1, a=0.00-0.5, and n=0-10 and having a unique diffraction pattern as given in TABLE 3.

The invention includes a method of synthesizing a crystalline silicate compound having the diffraction pattern similar to TABLE 2, by mixing together a source of silica, organic directing agent, water, and optional metal and heating at a temperature and time sufficient to crystallize the silicate.

The invention includes the use of ITQ-25 to separate hydrocarbons from a hydrocarbon containing stream.

The invention also includes the use of ITQ-25 as a hydrocarbon conversion catalyst for converting an organic feedstock to conversion products.

### BRIEF DESCRIPTION OF THE DRAWINGS

FIG. 1. 4,9-dimethyldecahydro-1H,5H-dipyrrolo[1,2-a:1′,2′-d]pyrazinediium organic directing agent.

FIG. 2 shows the framework structure of ITQ-25 showing only the tetrahedral atoms. There are four unit cells, whose edges are defined by the gray boxes.

Figure shows the X-ray diffraction pattern of as-synthesized ITQ-25.

FIG. 4 shows the X-ray diffraction pattern of calcined/dehydrated ITQ-25.

### DETAILED DESCRIPTION OF THE PREFERRED EMBODIMENTS

The present invention is a new structure. As with any porous crystalline material, the structure of ITQ-25 can be defined by the interconnections between the tetrahedrally coordinated atoms in its framework. In particular, ITQ-25 has a framework of tetrahedral (T) atoms connected by bridging atoms, wherein the tetrahedral atom framework is defined by connecting the nearest tetrahedral (T) atoms in the manner shown in TABLE 1.

TABLE 1
ITQ-25 tetrahedral atom interconnections

| T atom | Connected to: |
|---|---|
| T1 | T2, T6, T14, T32 |
| T2 | T1, T9, T13, T33 |
| T3 | T4, T11, T58, T68 |
| T4 | T3, T12, T57, T67 |
| T5 | T6, T8, T10, T67 |
| T6 | T1, T5, T7, T12 |
| T7 | T6, T9, T54, T65 |
| T8 | T5, T9, T53, T68 |
| T9 | T2, T7, T8, T11 |
| T10 | T5, T34, T61, T62 |
| T11 | T3, T9, T38, T60 |
| T12 | T4, T6, T35, T60 |
| T13 | T2, T14, T18, T25 |
| T14 | T1, T13, T21, T26 |
| T15 | T16, T23, T46, T75 |
| T16 | T15, T24, T45, T74 |
| T17 | T18, T20, T22, T74 |
| T18 | T13, T17, T19, T24 |
| T19 | T18, T21, T42, T72 |
| T20 | T17, T21, T41, T75 |
| T21 | T14, T19, T20, T23 |
| T22 | T17, T27, T49, T50 |
| T23 | T15, T21, T31, T48 |
| T24 | T16, T18, T28, T48 |
| T25 | T13, T26, T28, T33 |
| T26 | T14, T25, T31, T32 |
| T27 | T22, T28, T30, T45 |
| T28 | T24, T25, T27, T29 |
| T29 | T28, T31, T42, T43 |
| T30 | T27, T31, T41, T46 |
| T31 | T23, T26, T29, T30 |
| T32 | T1, T26, T33, T35 |
| T33 | T2, T25, T32, T38 |
| T34 | T10, T35, T37, T57 |
| T35 | T12, T32, T34, T36 |
| T36 | T35, T38, T54, T55 |
| T37 | T34, T38, T53, T58 |
| T38 | T11, T33, T36, T37 |
| T39 | T40, T44, T52, T70 |
| T40 | T39, T47, T51, T71 |
| T41 | T20, T30, T42, T49 |
| T42 | T19, T29, T41, T50 |
| T43 | T29, T44, T46, T48 |
| T44 | T39, T43, T45, T50 |
| T45 | T16, T27, T44, T47 |
| T46 | T15, T30, T43, T47 |
| T47 | T40, T45, T46, T49 |
| T48 | T23, T24, T43, T72 |
| T49 | T22, T41, T47, T76 |
| T50 | T22, T42, T44, T73 |
| T51 | T40, T52, T56, T63 |
| T52 | T39, T51, T59, T64 |
| T53 | T8, T37, T54, T61 |
| T54 | T7, T36, T53, T62 |
| T55 | T36, T56, T58, T60 |
| T56 | T51, T55, T57, T62 |
| T57 | T4, T34, T56, T59 |
| T58 | T3, T37, T55, T59 |
| T59 | T52, T57, T58, T61 |
| T60 | T11, T12, T55, T65 |
| T61 | T10, T53, T59, T69 |
| T62 | T10, T54, T56, T66 |
| T63 | T51, T64, T66, T71 |
| T64 | T52, T63, T69, T70 |
| T65 | T7, T60, T66, T68 |
| T66 | T62, T63, T65, T67 |
| T67 | T4, T5, T66, T69 |
| T68 | T3, T8, T65, T69 |
| T69 | T61, T64, T67, T68 |
| T70 | T39, T64, T71, T73 |
| T71 | T40, T63, T70, T76 |
| T72 | T19, T48, T73, T75 |
| T73 | T50, T70, T72, T74 |
| T74 | T16, T17, T73, T76 |
| T75 | T15, T20, T72, T76 |
| T76 | T49, T71, T74, T75 |

This new crystalline siliate compound has a composition InR:aX₂O₃:YO₂.nH₂O where R is an organic compound, X is of a trivalent metal capable of tetrahedral coordination such as one or more of B, Ga, Al, and Y is a tetravalent metal capable of tetrahedral coordination such as one or more of Ge, Si, Ti and where m=0.01-1, a=0.00-0.5, and n=0-10. This compound has the unique diffraction pattern given in TABLE 2.

Other embodiments of the new structure include a calcined compound of composition aX₂O₃:YO₂.nH₂O, where X is of a trivalent metal capable of tetrahedral coordination such as one or more of B, Ga, Al, Fe, and Y is a tetravalent metal capable of tetrahedral coordination such as one or more of Ge, Si, Ti and where a=0.00-0.5, and n=0-10. This compound has the unique diffraction pattern given in Table 3 when n<0.2.

This new compound is made by the method of mixing together a source of silica, organic directing agent, water, and optional source of metal and heating at a temperature and time sufficient to crystallize the silicate. The method is described below.

The synthetic porous crystalline material of this invention, ITQ-25, is a crystalline phase which has a unique 2-dimensional channel system comprising 14-membered rings of tetrahedrally coordinated atoms, intersecting with straight, 12-membered rings of tetrahedrally coordinated atoms. The 14-membered ring channels have cross-sectional dimensions between the bridging oxygen atoms of about 8.9 Angstroms by about 6.7 Angstroms, whereas the 12-membered ring channels have cross-sectional dimensions of about 8.4 Angstroms by about 5.8 Angstroms.

Variations in the X-ray diffraction pattern may occur between the different chemical composition forms of ITQ-25, such that the exact ITQ-25 structure can vary due its particular composition and whether or not it has been calcined and rehydrated.

In the as-synthesized form ITQ-25 has a characteristic X-ray diffraction pattern, the essential lines of which are given in TABLE 2 measured with Cu Kα radiation and 0.25° divergence slit. The line intensities are referenced to the strongest line (Iₒ), in this case the second line at about 12.4 Å. Variations occur as a function of specific composition and its loading in the structure. For this reason the intensities and d-spacings are given as ranges.

TABLE 2
Most significant X-ray diffraction lines for as-synthesized ITQ-25

| d-spacing(Å) | I/Iₒ(%) |
|---|---|
| 14.4-13.8 | 25-50 |
| 12.7-12.1 | 60-100 |
| 12.1-11.5 | 25-50 |
| 10.9-10.3 | 15-50 |
| 9.4-8.8 | 15-50 |
| 7.4-6.9 | 5-20 |
| 5.3-4.7 | 5-20 |
| 4.77-4.37 | 5-20 |
| 4.53-4.12 | 5-20 |
| 4.16-3.76 | 5-20 |
| 4.11-3.71 | 15-50 |
| 3.79-3.39 | 5-20 |
| 3.75-3.35 | 5-20 |
| 3.58-3.18 | 15-50 |

The ITQ-25 material of the present invention may be calcined to remove the organic templating agent without loss of crystallinity. This is useful for activating the material for subsequent absorption of other guest molecules such as hydrocarbons. The essential lines, which uniquely define calcined/dehydrated ITQ-25 are listed in TABLE 3 measured with synchrotron radiation using transmission geometry and a 0.8702 Å wavelength. As before, the line intensities are referenced to the strongest line (Iₒ), in this case second line at about 12.4 Å. Variations occur as a function of specific composition, temperature and the level of hydration in the structure. For this reason the intensities and d-spacings are given as ranges.

TABLE 3
Most significant X-ray diffraction lines
for calcined/dehydrated ITQ-25

| d-spacing(Å) | I/Iₒ(%) |
|---|---|
| 14.7-14.1 | 60-100 |
| 12.9-12.3 | 60-100 |
| 12.3-11.7 | 25-50 |
| 11.0-10.4 | 15-50 |
| 9.5-8.9 | 15-50 |
| 8.5-7.9 | 5-20 |
| 5.3-4.7 | 5-20 |
| 4.2-3.7 | 5-20 |
| 3.6-3.2 | 5-20 |

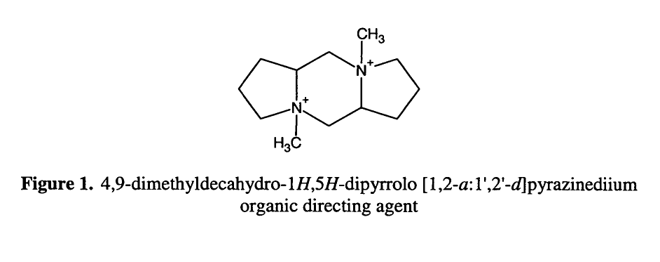

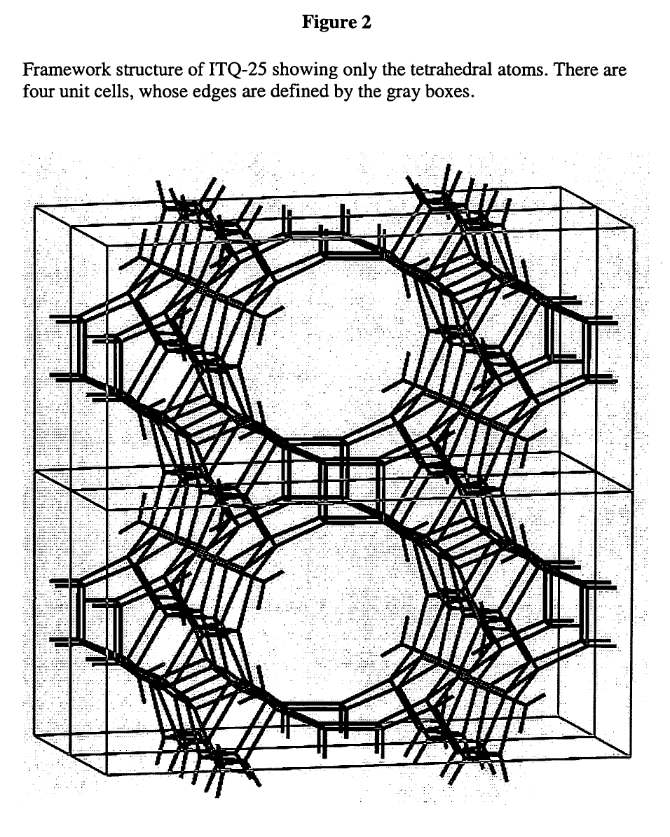

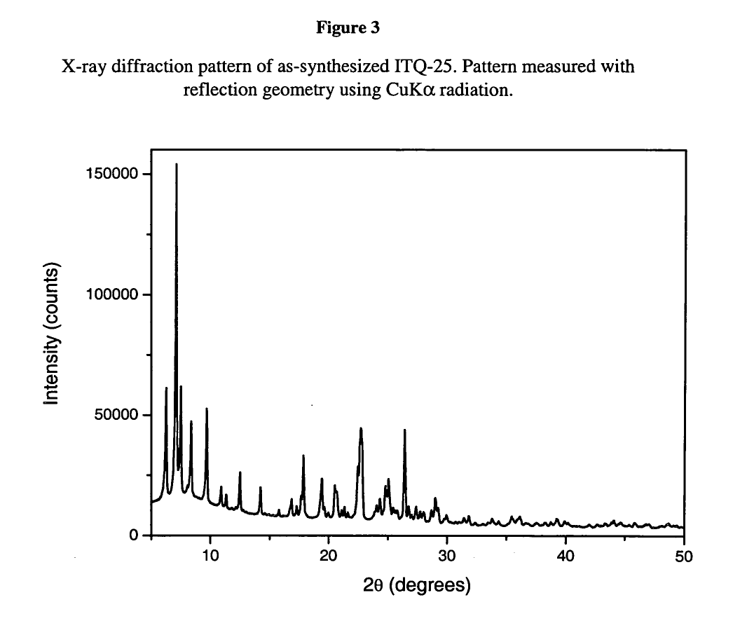

In addition, to describing the structure of ITQ-25 by the interconnections of the tetrahedral atoms as in TABLE 1 above, it may be defined by its unit cell, which is the smallest repeating unit containing all the structural elements of the material. The pore structure of ITQ-25 is illustrated in FIG. 2 (which shows only the tetrahedral atoms) down the direction of the 14-membered ring channel. There are four unit cell units in FIG. 1, whose limits are defined by the four boxes. TABLE 4 lists the typical positions of each tetrahedral atom in the unit cell in units of Angstroms. Each tetrahedral atom is bonded to bridging atoms, which are also bonded to adjacent tetrahedral atoms. Tetrahedral atoms are those capable of having tetrahedral coordination, including one or more of, but not limiting, lithium, beryllium, boron, magnesium, aluminum, silicon, phosphorous, titanium, chromium, manganese, iron, cobalt, nickel, copper, zinc, zirconium, gallium, germanium, arsenic, indium, tin, and antimony. Bridging atoms are those capable of connecting two tetrahedral atoms, examples which include, but not limiting, oxygen, nitrogen, fluorine, sulfur, selenium, and carbon atoms.

In the case of oxygen, it is also possible that the bridging oxygen is also connected to a hydrogen atom to form a hydroxyl group (—OH—). In the case of carbon it is also possible that the carbon is also connected to two hydrogen atoms to form a methylene group (—CH₂—). For example, bridging methylene groups have been seen in the zirconium diphosphonate, MIL-57. See: C. Serre, G. Férey, J. Mater. Chem. 12, p. 2367 (2002). Bridging sulfur and selenium atoms have been seen in the UCR-20-23 family of microporous materials. See: N. Zheng, X. Bu, B. Wang, P. Feng, Science 298, p. 2366 (2002). Bridging fluorine atoms have been seen in lithium hydrazinium fluoroberyllate, which has the ABW structure type. See: M. R. Anderson, I. D. Brown, S. Vilminot, Acta Cryst. B29, p. 2626 (1973). Since tetrahedral atoms may move about due to other crystal forces (presence of inorganic or organic species, for example), or by the choice of tetrahedral and bridging atoms, a range of ±1.0 Angstrom is implied for the x coordinate positions and a range of ±0.5 Angstrom for the y and z coordinate positions.

TABLE 4
Positions of tetrahedral (T) atoms for the ITQ-25 structure.
Values, in units of Angstroms, are approximate and are typical
when T = silicon and the bridging atoms are oxygen.

| Atom | x (Å) | y (Å) | z (Å) |
|---|---|---|---|
| T1 | 11.309 | 1.546 | 7.013 |
| T2 | 12.332 | 1.545 | 3.996 |
| T3 | 3.630 | 0.000 | 11.460 |
| T4 | 4.613 | 0.000 | 8.451 |
| T5 | 6.397 | 4.120 | 8.831 |
| T6 | 8.487 | 2.711 | 7.056 |
| T7 | 7.933 | 4.099 | 4.328 |
| T8 | 8.931 | 4.108 | −0.040 |
| T9 | 10.040 | 2.736 | 2.464 |
| T10 | 5.941 | 6.995 | 8.068 |
| T11 | 8.417 | 0.000 | 2.223 |
| T12 | 6.948 | 0.000 | 6.688 |
| T13 | 15.209 | 1.546 | 4.955 |
| T14 | 14.187 | 1.545 | 7.972 |
| T15 | 22.888 | 0.000 | 0.508 |
| T16 | 21.905 | 0.000 | 3.517 |
| T17 | 20.121 | 4.120 | 3.137 |
| T18 | 18.031 | 2.711 | 4.913 |
| T19 | 18.586 | 4.099 | 7.641 |
| T20 | 20.839 | 4.108 | 0.040 |
| T21 | 16.478 | 2.736 | 9.504 |
| T22 | 20.578 | 6.995 | 3.900 |
| T23 | 18.101 | 0.000 | 9.745 |
| T24 | 19.570 | 0.000 | 5.280 |
| T25 | 15.209 | 12.444 | 4.955 |
| T26 | 14.187 | 12.445 | 7.972 |
| T27 | 20.121 | 9.870 | 3.137 |
| T28 | 18.031 | 11.279 | 4.913 |
| T29 | 18.586 | 9.891 | 7.641 |
| T30 | 20.839 | 9.882 | 0.040 |
| T31 | 16.478 | 11.254 | 9.504 |
| T32 | 11.309 | 12.444 | 7.013 |
| T33 | 12.332 | 12.445 | 3.996 |
| T34 | 6.397 | 9.870 | 8.831 |
| T35 | 8.487 | 11.279 | 7.056 |
| T36 | 7.933 | 9.891 | 4.328 |
| T37 | 8.931 | 9.882 | −0.040 |
| T38 | 10.040 | 11.254 | 2.464 |
| T39 | 26.194 | 8.541 | 7.013 |
| T40 | 27.217 | 8.540 | 3.996 |
| T41 | 18.515 | 6.995 | 11.460 |
| T42 | 19.498 | 6.995 | 8.451 |
| T43 | 21.282 | 11.115 | 8.831 |
| T44 | 23.372 | 9.706 | 7.056 |
| T45 | 22.818 | 11.094 | 4.328 |
| T46 | 23.816 | 11.103 | −0.040 |
| T47 | 24.925 | 9.731 | 2.464 |
| T48 | 20.826 | 0.000 | 8.068 |
| T49 | 23.302 | 6.995 | 2.223 |
| T50 | 21.833 | 6.995 | 6.688 |
| T51 | 0.324 | 8.541 | 4.955 |
| T52 | −0.698 | 8.540 | 7.972 |
| T53 | 8.003 | 6.995 | 0.508 |
| T54 | 7.020 | 6.995 | 3.517 |
| T55 | 5.236 | 11.115 | 3.137 |
| T56 | 3.146 | 9.706 | 4.913 |
| T57 | 3.701 | 11.094 | 7.641 |
| T58 | 5.954 | 11.103 | 0.040 |
| T59 | 1.593 | 9.731 | 9.504 |
| T60 | 5.693 | 0.000 | 3.900 |
| T61 | 3.216 | 6.995 | 9.745 |
| T62 | 4.685 | 6.995 | 5.280 |
| T63 | 0.324 | 5.449 | 4.955 |
| T64 | −0.698 | 5.450 | 7.972 |
| T65 | 5.236 | 2.875 | 3.137 |
| T66 | 3.146 | 4.284 | 4.913 |
| T67 | 3.701 | 2.896 | 7.641 |
| T68 | 5.954 | 2.887 | 0.040 |
| T69 | 1.593 | 4.259 | 9.504 |
| T70 | 26.194 | 5.449 | 7.013 |
| T71 | 27.217 | 5.450 | 3.996 |
| T72 | 21.282 | 2.875 | 8.831 |
| T73 | 23.372 | 4.284 | 7.056 |
| T74 | 22.818 | 2.896 | 4.328 |
| T75 | 23.816 | 2.887 | −0.040 |
| T76 | 24.925 | 4.259 | 2.464 |

The complete structure of ITQ-25 is built by connecting multiple unit cells as defined above in a fully-connected three-dimensional framework. The tetrahedral atoms in one unit cell are connected to certain tetrahedral atoms in all of its adjacent unit cells. While TABLE 1 lists the connections of all the tetrahedral atoms for a given unit cell of ITQ-25, the connections may not be to the particular atom in the same unit cell but to an adjacent unit cell. All of the connections listed in TABLE 1 are such that they are to the closest tetrahedral (T) atoms, regardless of whether they are in the same unit cell or in adjacent unit cells.

Although the Cartesian coordinates given in TABLE 4 may accurately reflect the positions of tetrahedral atoms in an idealized structure, the true structure can be more accurately described by the connectivity between the framework atoms as shown in TABLE 1 above. Another way to describe this connectivity is by the use of coordination sequences as applied to microporous frameworks by W. M. Meier and H. J. Moeck, in the Journal of Solid State Chemistry 27, p. 349 (1979). In a microporous framework, each tetrahedral atom, N₀, (T-atom) is connected to N₁=4 neighboring T-atoms through bridging atoms (typically oxygen). These neighboring T-atoms are then connected to N₂ T-atoms in the next shell. The N₂ atoms in the second shell are connected to N₃ T-atoms in the third shell, and so on. Each T-atom is only counted once, such that, for example, if a T-atom is in a 4-membered ring, at the fourth shell the N₀ atom is not counted second time, and so on. Using this methodology, a coordination sequence can be determined for each unique T-atom of a 4-connected net of T-atoms. The following line lists the maximum number of T-atoms for each shell.

N₀=1 N₁≦4 N₂≦12 N₃≦36 Nₖ≦4·3^{k-1}

TABLE 5
Coordination sequence for ITQ-25 structure.

| atom | atom | | | | | | | | | | | | | |
|---|---|---|---|---|---|---|---|---|---|---|---|---|---|---|
| number | label | coordination sequence | | | | | | | | | | | | |
| 1 | T(1) | 4 | 9 | 18 | 32 | 53 | 79 | 105 | 130 | 166 | 220 | 263 | 311 | 360 |
| 2 | T(2) | 4 | 9 | 18 | 32 | 53 | 80 | 104 | 129 | 171 | 217 | 264 | 308 | 360 |
| 3 | T(3) | 4 | 12 | 20 | 36 | 50 | 67 | 102 | 145 | 178 | 223 | 252 | 284 | 361 |
| 4 | T(4) | 4 | 12 | 24 | 34 | 46 | 71 | 107 | 147 | 176 | 215 | 249 | 300 | 372 |
| 5 | T(5) | 4 | 12 | 22 | 34 | 49 | 73 | 102 | 144 | 181 | 213 | 246 | 306 | 371 |
| 6 | T(6) | 4 | 12 | 22 | 33 | 52 | 76 | 107 | 144 | 173 | 208 | 259 | 311 | 370 |
| 7 | T(7) | 4 | 12 | 21 | 34 | 48 | 73 | 106 | 140 | 176 | 208 | 255 | 310 | 364 |
| 8 | T(8) | 4 | 12 | 21 | 34 | 49 | 71 | 102 | 139 | 183 | 215 | 251 | 298 | 364 |
| 9 | T(9) | 4 | 12 | 20 | 31 | 53 | 76 | 104 | 140 | 170 | 212 | 255 | 315 | 351 |
| 10 | T(10) | 4 | 12 | 20 | 34 | 48 | 68 | 107 | 141 | 178 | 211 | 242 | 298 | 372 |
| 11 | T(11) | 4 | 12 | 20 | 28 | 51 | 73 | 100 | 144 | 172 | 208 | 256 | 287 | 365 |
| 12 | T(12) | 4 | 12 | 22 | 30 | 49 | 73 | 106 | 145 | 179 | 199 | 250 | 315 | 362 |

One way to determine the coordination sequence for a given structure is from the atomic coordinates of the framework atoms using the computer program zeoTsites (see G. Sastre, J. D. Gale, Microporous and mesoporous Materials 43, p. 27 (2001).

The coordination sequence for the ITQ-25 structure is given in TABLE 5. The T-atom connectivity as listed in Tables 1 and 5 is for T-atoms only. Bridging atoms, such as oxygen usually connects the T-atoms. Although most of the T-atoms are connected to other T-atoms through bridging atoms, it is recognized that in a particular crystal of a material having a framework structure, it is possible that a number of T-atoms may not connected to one another. Reasons for non-connectivity include, but are not limited by, T-atoms located at the edges of the crystals and by defects sites caused by, for example, vacancies in the crystal. The framework listed in TABLE 1 and TABLE 5 is not limited in any way by its composition, unit cell dimensions or space group symmetry.

While the idealized structure contains only 4-coordinate T-atoms, it is possible under certain conditions that some of the framework atoms may be 5- or 6-coordinate. This may occur, for example, under conditions of hydration when the composition of the material contains mainly phosphorous and aluminum T-atoms. When this occurs it is found that T-atoms may be also coordinated to one or two oxygen atoms of water molecules (—OH₂), or of hydroxyl groups (—OH). For example, the molecular sieve AlPO₄-34 is known to reversibly change the coordination of some aluminum T-atoms from 4-coordinate to 5- and 6-coordinate upon hydration as described by A. Tuel et al. in J. Phys. Chem. B 104, p. 5697 (2000). It is also possible that some framework T-atoms can be coordinated to fluoride atoms (—F) when materials are prepared in the presence of fluorine to make materials with 5-coordinate T-atoms as described by H. Koller in J. Am. Chem Soc. 121, p. 3368 (1999).

The invention also includes a method of synthesizing a crystalline silicate composition of ITQ-25 having the diffraction pattern similar to TABLE 2, by mixing together a source of silica, organic directing agent (R), water, and optional metal (Me), with a composition, in terms of mole ratios, within the following ranges:

| | |
|---|---|
| R/SiO₂ | 0.01-1 |
| H₂O/SiO₂ | 2-50 |
| Me/SiO₂ | 0-.5 |

and preferably within the following ranges:

| | |
|---|---|
| R/SiO₂ | 0.1-.5 |
| H₂O/SiO₂ | 5-20 |
| Me/SiO₂ | 0-.1 |

Me is any metal capable of tetrahedral coordination such as one or more of B, Ga, Al, Ge, Zn, Fe, Co, Ni, Be, Mn, Ti, Zr.

Said organic directing agent is preferably 4,9-dimethyldecahydro-1H,5H-dipyrrolo[1,2-a:1′,2′-d]pyrazinediium. See FIG. 1. Sources of silica can be colloidal, fumed or precipitated silica, silica gel, sodium or potassium silicates, or organic silicon such as tetraethyhlorthosilicate, etc. Sources of metal can be boric acid, germanium (IV) ethoxide, germanium oxide, germanium nitrate, aluminum nitrate, sodium aluminate, aluminum sulfate, aluminum hydroxide, aluminum chloride and various salts of the metals (Me) such as zinc nitrate, cobalt acetate, iron chloride, and magnesium nitrate, etc. The mixture is then heated at a temperature and time sufficient to crystallize the silicate.

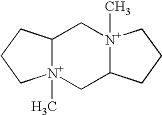

### FIG. 1. 4,9-dimethyldecahydro-1H,5H-dipyrrolo[1,2-a:1′,2′-d]pyrazinediium Organic Directing Agent

To the extent desired and depending on the X₂O₃/YO₂ molar ratio of the material, any cations present in the as-synthesized ITQ-25 can be replaced in accordance with techniques well known in the art by ion exchange with other cations. Preferred replacing cations include metal ions, hydrogen ions, and hydrogen precursor, e.g., ammonium ions and mixtures thereof. Particularly preferred cations are those which tailor the catalytic activity for certain hydrocarbon conversion reactions. These include hydrogen, rare earth metals and metals of Groups IIA, IIIA, IVA, VA, IB, IIB, IIIB, IVB, VB, VIIB, VIIB and VIII of the Periodic Table of the Elements.

The crystalline material of this invention can be used to catalyze a wide variety of chemical conversion processes, particularly organic compound conversion processes, including many of present commercial/industrial importance. Examples of chemical conversion processes which are effectively catalyzed by the crystalline material of this invention, by itself or in combination with one or more other catalytically active substances including other crystalline catalysts, include those requiring a catalyst with acid activity.

Thus, in its active form ITQ-25 can exhibit a high acid activity, which can be measured with the alpha test. Alpha value is an approximate indication of the catalytic cracking activity of the catalyst compared to a standard catalyst and it gives the relative rate constant (rate of normal hexane conversion per volume of catalyst per unit time). It is based on the activity of silica-alumina cracking catalyst taken as an Alpha of 1 (Rate Constant=0.016 sec-1). The Alpha Test is described in U.S. Pat. No. 3,354,078; in the Journal of Catalysis 4, 527 (1965); 6, 278 (1966); and 61, 395 (1980), each incorporated herein by reference as to that description. The experimental conditions of the test used herein include a constant temperature of 538° C. and a variable flow rate as described in detail in the Journal of Catalysis 61, 395 (1980).

When used as a catalyst, the crystalline material of the invention may be subjected to treatment to remove part or all of any organic constituent. This is conveniently effected by thermal treatment in which the as-synthesized material is heated at a temperature of at least about 370° C. for at least 1 minute and generally not longer than 20 hours. While subatmospheric pressure can be employed for the thermal treatment, atmospheric pressure is desired for reasons of convenience. The thermal treatment can be performed at a temperature up to about 925° C. The thermally treated product, especially in its metal, hydrogen and ammonium forms, is particularly useful in the catalysis of certain organic, e.g., hydrocarbon, conversion reactions.

When used as a catalyst, the crystalline material can be intimately combined with a hydrogenating component such as tungsten, vanadium, molybdenum, rhenium, nickel, cobalt, chromium, manganese, or a noble metal such as platinum or palladium where a hydrogenation-dehydrogenation function is to be performed. Such component can be in the composition by way of cocrystallization, exchanged into the composition to the extent a Group IIIA element, e.g., aluminum, is in the structure, impregnated therein or intimately physically admixed therewith. Such component can be impregnated in or on to it such as, for example, by, in the case of platinum, treating ITQ-25 with a solution containing a platinum metal-containing ion. Thus, suitable platinum compounds for this purpose include chloroplatinic acid, platinous chloride and various compounds containing the platinum amine complex.

The crystalline material of this invention, when employed either as an adsorbent or as a catalyst in an organic compound conversion process should be dehydrated, at least partially. This can be done by heating to a temperature in the range of 100° C. to about 370° C. in an atmosphere such as air, nitrogen, etc., and at atmospheric, subatmospheric or superatmospheric pressures for between 30 minutes and 48 hours. Dehydration can also be performed at room temperature merely by placing the ITQ-25 in a vacuum, but a longer time is required to obtain a sufficient amount of dehydration.

As in the case of many catalysts, it may be desirable to incorporate the new crystal with another material resistant to the temperatures and other conditions employed in organic conversion processes. Such materials include active and inactive materials and synthetic or naturally occurring zeolites as well as inorganic materials such as clays, silica and/or metal oxides such as alumina. The latter may be either naturally occurring or in the form of gelatinous precipitates or gels including mixtures of silica and metal oxides. Use of a material in conjunction with the new crystal, i.e., combined therewith or present during synthesis of the new crystal, which is active, tends to change the conversion and/or selectivity of the catalyst in certain organic conversion processes. Inactive materials suitably serve as diluents to control the amount of conversion in a given process so that products can be obtained economically and orderly without employing other means for controlling the rate of reaction. These materials may be incorporated into naturally occurring clays, e.g., bentonite and kaolin, to improve the crush strength of the catalyst under commercial operating conditions. Said materials, i.e., clays, oxides, etc., function as binders for the catalyst. It is desirable to provide a catalyst having good crush strength because in commercial use it is desirable to prevent the catalyst from breaking down into powder-like materials. These clay and/or oxide binders have been employed normally only for the purpose of improving the crush strength of the catalyst.

Naturally occurring clays which can be composited with the new crystal include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or initially subjected to calcination, acid treatment or chemical modification. Binders useful for compositing with the present crystal also include inorganic oxides, such as silica, zirconia, titania, magnesia, beryllia, alumina, and mixtures thereof.

In addition to the foregoing materials, the new crystal can be composited with a porous matrix material such as silica-alumina, silica-magnesia, silica-zirconia, silica-thoria, silica-beryllia, silica-titania as well as ternary compositions such as silica-alumina-thoria, silica-alumina-zirconia silica-alumina-magnesia and silica-magnesia-zirconia.

The relative proportions of finely divided crystalline material and inorganic oxide matrix vary widely, with the crystal content ranging from about 1 to about 90 percent by weight and more usually, particularly when the composite is prepared in the form of beads, in the range of about 2 to about 80 weight percent of the composite.

In order to more fully illustrate the nature of the invention and the manner of practicing same, the following examples are presented.

### EXAMPLES

### Example 1

### Synthesis of methyl 1-(tert-butoxycarbonyl)prolylprolinate

In a 1 litre flask, 9.95 g of L-proline methyl ester hydrochloride (60 mmol), were dissolved in 400 ml of CH₂Cl₂. Then, 12.92 g (60 mmol) of t-boc-L-proline, 6.06 g (60 mmol) of triethylamine and 12.38 g (60 mmol) of condensing agent dicyclohexyl carbodiimide (DCC) were added at 0° C., and maintained under stirring for 48 hours. A solid precipitated, that was filtered and washed with CH₂Cl₂. Then, the liquid phase is washed first with HCl 1 N, then with KHCO₃ 1 N and finally with water (90 ml each). Finally, it was dried with anhydrous MgSO₄, filtered and vacuum evaporated to dryness to give 18.71 g (95.6%) of methyl 1-(tert-butoxycarbonyl) prolylprolinate

### Example 2

### Synthesis of decahydro-5H,10H-dipyrrolo[1,2-a:1′,2′-d]pyrazine-5,10-dione

17.3 g of methyl 1-(tert-butoxycarbonyl)prolylprolinate were dissolved in 500 ml of HCOOH (98%, 100 ml/g of dipeptide) in a 1000 ml round-bottomed flask and maintained the solution at room temperature under stirring for 8 hours. After removal of the HCOOH in vacuum at low temperature (less than 30° C.), the residue was dissolved in 2-butanol (300 ml) and toluene (150 ml) and the solution refluxed for 3 hours. After concentrating the solution, the diketopiperazine (decahydro-5H,10H-dipyrrolo[1,2-a:1′,2′-d]pyrazine-5, 10-dione) crystallised. The product was filtered and washed with diethyl ether. The final yield is 78.2% (8.05 g).

### Example 3

### Synthesis of decahydro-1H,5H-dipyrrolo[1,2-a:1′, 2′-d]pyrazine

All glassware in this procedure was carefully dried. To a 1000 ml, 3-necked round-bottomed flask, equipped with a magnetic stirring bar, a graduated pressure equalized addition funnel containing 6.74 g (34.72 mmol) of decahydro-5H,10H-dipyrrolo[1,2-a:1′,2′-d]pyrazine-5,10-dione, previously dissolved in 150 ml of anhydrous THF, and a reflux condenser topped with an inline gas bubbler flushed with N₂ was attached. The flask was then charged with lithium aluminium hydride powder (2.64 g, 69.6 mmol) and anhydrous THF (50 ml). Under stirring, the decahydro-5H,10H-dipyrrolo[1,2-a:1′,2′-d]pyrazine-5,10-dione solution was added slowly and the mixture refluxed for three hours. After subsequent cooling to 5° C., the reaction was quenched with water (15 ml), 15% NaOH solution (15 ml) and water (15 m), keeping the temperature below 15° C. After warming to room temperature and suction filtration of the solids, they were washed with dichloromethane (200 ml). The organic layer was separated, dried over MgSO4, re-filtered and the solvent evaporated under vacuum to give 4.56 g of a clear oil that corresponds to decahydro-1H,5H-dipyrrolo[1,2-a:1′,2′-d] pyrazine

### Example 4

### Synthesis of 4,9-dimethyldecahydro-1H,5H-dipyrrolo[1,2-a:1′,2′-d]pyrazinediium hydroxide

To a 500 ml round-bottomed flask, equipped with a magnetic stirring bar, a graduated pressure equalized addition funnel containing 25 g (176 mmol) of iodomethane was attached. The flask was then charged with decahydro-1H,5H-dipyrrolo[1,2-a:1′, 2′-d]pyrazine (9.30 g, 56 mmol) and methanol (150 ml). After stirring until the solid have dissolved, the iodomethane was added slowly and the mixture left for 3 days. Then, the solvent was evaporated under vacuum to give 20.90 g (83%) of a white solid that corresponds to 4,9-dimethyldecahydro-1H,5H-dipyrrolo[1,2-a:1′, 2′-d]pyrazinediium iodide.

This 20.90 g of 4,9-dimethyldecahydro-1H,5H-dipyrrolo[1,2-a:1′, 2′-d]pyrazinediium iodide, previously dissolved in water, were converted to the corresponding hydroxide with 93 g of an anionic exchange resin in batch overnight, yielding 118.86 g of a solution of 4,9-dimethyldecahydro-1H,5H-dipyrrolo[1,2-a:1′, 2′-d]pyrazinediium hydroxide with a concentration of 0.75 mol OH/Kg (96% of exchange yield) that will be used as SDA source.

### Example 5

### Synthesis of ITQ-25

0.35 g of germanium oxide were dissolved in 13.97 g of a solution of 4,9-dimethyldecahydro-1H,5H-dipyrrolo[1,2-a:1′,2′-d]pyrazinediium hydroxide with a concentration of 0.72 mol OH/Kg. Then, 3.47 g of tetraethylorthosilicate (TEOS) were hydrolyzed in the solution formed and the mixture was maintained under stirring until all the ethanol formed in the hydrolysis was evaporated and 6.11 grams of gel remained. The final composition was:
0.833 SiO₂:0.167 GeO₂:0.25 MPRO(OH)₂:10H₂O
where MPRO(OH)₂ is 4,9-dimethyldecahydro-1H,5H-dipyrrolo[1,2-a:1′, 2′-d]pyrazinediium hydroxide.

The gel was heated in Teflon-lined stainless steel autoclaves at 175° C. under tumbling for 12 days. The solid was filtered, washed with deionized water and dried at 100° C. to yield the new material designated as ITQ-25. This sample was then subjected to X-ray powder diffraction using CuKα radiation. The d-spacings and integrated peak intensities are given in Table 6 below and the diffraction pattern is shown in Figure.

TABLE 6
X-ray diffraction pattern of as-synthesized ITQ-25

| d(Å) | I % |
|---|---|
| 14.1 | 34.7 |
| 12.4 | 100.0 |
| 11.8 | 35.8 |
| 10.6 | 25.6 |
| 9.12 | 29.5 |
| 8.12 | 6.9 |
| 7.81 | 4.8 |
| 7.49 | 1.0 |
| 7.30 | 1.4 |
| 7.09 | 11.9 |
| 6.23 | 8.3 |
| 6.07 | 0.5 |
| 5.62 | 1.8 |
| 5.26 | 5.2 |
| 5.13 | 3.1 |
| 5.02 | 6.1 |
| 4.964 | 18.2 |
| 4.569 | 11.7 |
| 4.523 | 3.3 |
| 4.441 | 1.6 |
| 4.327 | 9.8 |
| 4.288 | 7.7 |
| 4.208 | 2.6 |
| 4.160 | 3.6 |
| 4.103 | 2.0 |
| 3.957 | 15.8 |
| 3.913 | 27.5 |
| 3.724 | 2.5 |
| 3.700 | 4.4 |
| 3.656 | 6.4 |
| 3.593 | 10.0 |
| 3.554 | 12.5 |
| 3.502 | 3.9 |
| 3.474 | 3.1 |
| 3.452 | 3.1 |
| 3.375 | 27.2 |
| 3.334 | 4.6 |
| 3.303 | 2.1 |
| 3.258 | 4.6 |
| 3.219 | 3.1 |
| 3.182 | 2.9 |
| 3.115 | 3.6 |
| 3.082 | 7.3 |
| 3.054 | 4.5 |
| 3.001 | 1.3 |
| 2.984 | 2.5 |
| 2.910 | 0.6 |
| 2.884 | 0.6 |
| 2.847 | 1.8 |
| 2.810 | 2.4 |
| 2.766 | 0.6 |
| 2.713 | 0.2 |
| 2.679 | 0.7 |
| 2.654 | 1.9 |
| 2.614 | 1.1 |
| 2.534 | 2.7 |
| 2.487 | 2.7 |
| 2.455 | 0.8 |
| 2.396 | 0.9 |
| 2.354 | 1.1 |
| 2.325 | 1.3 |
| 2.294 | 2.3 |
| 2.293 | 2.0 |
| 2.257 | 1.6 |
| 2.241 | 1.1 |
| 2.194 | 0.2 |
| 2.150 | 0.7 |
| 2.117 | 0.8 |
| 2.088 | 1.1 |
| 2.062 | 1.5 |
| 2.053 | 2.1 |
| 2.029 | 1.5 |

### Example 6

### Synthesis of ITQ-25

The synthesis gel used for this synthesis had the following molar composition:
0.833 SiO₂:0.167 GeO₂:0.25 MPRO(OH)₂:10H₂O
where MPRO(OH)₂ is 4,9-dimethyldecahydro-1H,5H-dipyrrolo[1,2-a:1′,2′-d]pyrazinediium hydroxide.

The gel was prepared by dissolving 0.39 g of germanium oxide in 14.56 g of a solution of 4,9-dimethyldecahydro-1H,5H-dipyrrolo[1,2-a:1′,2′-d]pyrazinediium hydroxide with a concentration of 0.75 mol OH/Kg and hydrolyzing 3.83 g of tetraethylorthosilicate (TEOS) in the solution formed under continuous mechanical stirring until all the ethanol and the appropriate amount of water were evaporated to yield the above gel reaction mixture.

The gel was autoclaved at 150° C. under stirring for 24 days. The solid, ITQ-25, was recovered by filtration, washed with distilled water and dried at 100° C.

### Example 7

### Synthesis of A1-ITQ-25

The aluminum containing ITQ-25 material was prepared with the following gel composition:
0.833 SiO₂:0.167 GeO₂:0.01 Al₂O₃:0.25 MPRO(OH)₂:10H₂O
where MPRO(OH)₂ is 4,9-dimethyldecahydro-1H,5H-dipyrrolo[1,2-a:1′, 2′-d]pyrazinediium hydroxide.

1.25 g of germanium oxide were dissolved in 97.30 g of 4,9-dimethyldecahydro-1H,5H-dipyrrolo[1,2-a:1′,2′-d]pyrazinediium hydroxide with a concentration of 0.37 mol OH/Kg. Then, 12.50 g of tetraethylorthosilicate (TEOS) and 0.31 g of aluminum isopropoxide were hydrolyzed in the solution formed and the mixture was maintained under stirring until all the alcohol formed in the hydrolysis was evaporated and the desired composition was reached.

The gel was heated in Teflon-lined stainless steel autoclaves at 175° C. under stirring conditions for 11 days. The solid was filtered, washed with deionized water and dried at 1001C. The XRD pattern of the sample correspond to that of ITQ-25.

### Example 8

### Synthesis of A1-ITQ-25

0.53 g of germanium oxide were dissolved in 55.57 g of a solution of 4,9-dimethyldecahydro-1H,5H-dipyrrolo[1,2-a:1′, 2′-d]pyrazinediium hydroxide with a concentration of 0.27 mol OH/Kg. Then, 3.47 g of tetraethylorthosilicate (TEOS) and 0.10 g of aluminum isopropoxide were hydrolyzed in the solution formed and the mixture was maintained under stirring until all the ethanol was evaporated and 9.11 g of gel remained. The final composition was:
0.833 SiO₂:0.167 GeO₂:0.0083 Al₂O₃:0.25 MPRO(OH)₂:10H₂O
where MPRO(OH)₂ is 4,9-dimethyldecahydro-1H,5H-dipyrrolo[1,2-a:1′, 2′-d]pyrazinediium hydroxide.

The gel was autoclaved at 175° C. under tumbling for 11 days. The solid was filtered, washed with deionized water and dried at 100° C. to yield ITQ-25.

### Example 9

### Calcination of ITQ-25

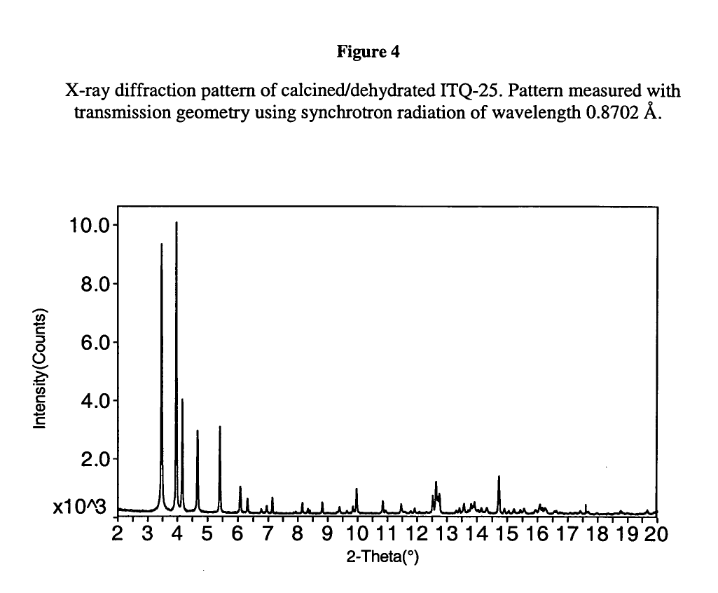

A portion of an as-synthesized ITQ-25 sample from example 5 was calcined in an air furnace by ramping over a period of two hours from room temperature to 600° C. and holding for 64 hours. While still hot the sample was placed in a 2 mm quartz capilary tube and sealed under vacuum. This sample was then subjected to X-ray powder diffraction using synchrotron radiation having a wavelength of 0.8702 Å. The d-spacings and integrated peak intensities are given in TABLE 7 below and the diffraction pattern is shown in FIG. 4.

TABLE 7
X-ray diffraction pattern of calcined/dehydrated
ITQ-25 measured at 0.8702 Å.

| d(Å) | I % |
|---|---|
| 14.4 | 92.8 |
| 12.6 | 100.0 |
| 12.0 | 38.7 |
| 10.7 | 28.3 |
| 9.22 | 29.8 |
| 8.21 | 9.2 |
| 7.90 | 5.0 |
| 7.37 | 1.6 |
| 7.18 | 2.6 |
| 6.99 | 5.5 |
| 6.29 | 0.7 |
| 6.12 | 3.7 |
| 5.99 | 1.7 |
| 5.66 | 3.9 |
| 5.56 | 0.3 |
| 5.36 | 0.5 |
| 5.32 | 2.2 |
| 5.18 | 0.9 |
| 5.07 | 2.4 |
| 5.01 | 8.6 |
| 4.603 | 4.3 |
| 4.564 | 1.2 |
| 4.357 | 3.3 |
| 4.239 | 0.8 |
| 4.191 | 1.8 |
| 4.135 | 0.6 |
| 4.058 | 0.4 |
| 3.989 | 6.2 |
| 3.954 | 11.0 |
| 3.934 | 5.8 |
| 3.920 | 6.8 |
| 3.753 | 1.1 |
| 3.724 | 1.9 |
| 3.683 | 3.4 |
| 3.643 | 1.1 |
| 3.619 | 3.2 |
| 3.591 | 3.8 |
| 3.560 | 1.2 |
| 3.534 | 1.9 |
| 3.492 | 1.9 |
| 3.397 | 12.8 |
| 3.355 | 1.6 |
| 3.321 | 1.0 |
| 3.284 | 1.6 |
| 3.258 | 0.3 |
| 3.241 | 1.3 |
| 3.215 | 1.8 |
| 3.140 | 1.4 |
| 3.112 | 3.2 |
| 3.096 | 2.2 |
| 3.080 | 2.1 |
| 3.022 | 0.9 |
| 3.011 | 1.1 |
| 2.990 | 0.6 |
| 2.978 | 0.6 |
| 2.929 | 0.5 |
| 2.902 | 0.4 |
| 2.873 | 1.1 |
| 2.831 | 0.9 |
| 2.668 | 1.2 |
| 2.660 | 0.7 |
| 2.653 | 0.4 |
| 2.547 | 1.4 |
| 2.516 | 0.9 |
| 2.505 | 1.0 |

1. A synthetic crystalline material having a framework of tetrahedral atoms (T) connected by bridging atoms, the tetrahedral atom framework being defined by connecting the nearest tetrahedral (T) atoms in the manner shown in TABLE 1 of the specification.

2. A synthetic porous crystalline material, as synthesized, characterized by an X-ray diffraction pattern including the most significant lines substantially as set forth in TABLE 2 of the specification.

3. The calcined dehydrated materials of claim 1 or claim 2 characterized by an X-ray diffraction pattern including the most significant lines substantially, as set forth in TABLE 3 of the specification.

4. The crystalline material of claim 1 wherein said tetrahedral atoms include one or more elements selected from the group consisting of Li, Be, Li, Al, P, Si, Ga, Ge, Zn, Cr, Mg, Fe, Co, Ni, Be, Mn, As, In, Sn, Sb, Ti, and Zr.

5. The crystalline material of claim 1 wherein said bridging atoms include one or more elements selected from the group consisting of O, N, F, S, Se, and C.

6. A process for the separation of hydrocarbons from a hydrocarbon containing stream using a form of the synthetic porous crystalline material of claim 1.

7. A process for converting a feedstock comprising organic compounds to conversion product which comprises contacting said feedstock at organic compound conversion conditions with a catalyst comprising an active form of the synthetic porous crystalline material of claim 1.
